(19) United States
(12) Patent Application Publication
(10) Pub. No.: US 2019/0102336 A1
(43) Pub. Date: Apr. 4, 2019

(54) Modular Data Acquisition System

(71) Applicants: Warren Peter Canning, Kyneton (AU); Daniel Lok-Kun Ho, Balwyn North (AU)

(72) Inventors: Warren Peter Canning, Kyneton (AU); Daniel Lok-Kun Ho, Balwyn North (AU)

(21) Appl. No.: 16/147,900

(22) Filed: Oct. 1, 2018

(30) Foreign Application Priority Data
Oct. 3, 2017 (AU) 2017903979

(51) Int. Cl. G06F 13/40; G06F 1/26

(52) U.S. Cl. CPC G06F 13/4081; G06F 1/266

(57) ABSTRACT

The present invention is a mobile modular data acquisition system including at least one module, and interconnect means, that are adapted to connect a pair of adjacent modules, in the data acquisition system together. Each module in the data acquisition system includes a first face, and a second face, that is located opposite to the first face, and when two modules are placed side by side and connected together, the first face of the first module is in physical contact with the second face of the second module. Preferably, when two modules are connected together, there is an electrical connection path between the modules.

### SCOPE OF THE INVENTION

The present invention relates to modular data acquisition systems.

### BACKGROUND OF THE INVENTION

There are plurality of modular data acquisition systems available. Some of these are characterized as being portable, and others are characterized as being ultra-portable. One example of such a system is the DATaRec 4 series by Zodiac Aerospace Systems. Systems such as these include a core unit with a variety of modules that may be added or removed from the data acquisition system to best service the needs of the system for any particular application. Each of the modules is self-contained, and is connected separately to an external power supply, and any data interconnection between separate modules in the system is done via external cabling. In some systems, adjacent modules may be physically latched together. In all cases, these latches, if used, provided only mechanical locking only, and do not facilitate other uses, such as the interconnection of data or power connection.

There are several significant problems with this type of system. Firstly, the plethora of cables that are used to interconnect the modules used at any time in the data acquisition system, is comparatively cumbersome, and requires time and skill to ensure the modules are cabled together properly. Further, each cable interconnect is a potential mode of failure between two modules, and this may incapacitate the entire system. In addition, the plurality of cable connectors may not be able to meet rigorous military standards governing vibration resistance for both land and aerospace vehicles. The cables may be easily snagged when the unit is being installed, and/or reconfigured, and this may be another mode of failure. The act of snagging may damage the cable connector, and may render the module non-functional, and requiring repair. These types of systems are also the least compact. In many applications for such systems, particularly in aerospace vehicle applications, the space available for the data acquisition system is extremely limited.

Another type of data acquisition system comprises a housing that has a plurality of slots included within it. The slots are each connected to an integrated circuit board. Individual modules can then be inserted into a spare slot. The data acquisition system of this type can have as many modules incorporated into it as there are slots in the housing. This arrangement does away with the multiple cable interconnections, and can also be designed to be more compact, however it introduces other problems. Firstly, the data acquisition system is limited by the finite number of slots within any particular housing. The user of such a system needs to keep an inventory of different housings so that data acquisition systems with a wide variety of numbers of modules, and thereby capabilities, may be assembled. Further to this, when each module is inserted within a slot, often it is then braced in position to prevent vibratory forces from causing it to work loose during use. This means that a user needs to access the internals of the housing in order to swap in or out, or rearrange modules, within the housing. This is time consuming and inefficient, and prevents “hot swapping” of modules. Further to this, there is another significant problem associated with the physical constraints on the size of each module that is able to be inserted into the available slots. The module cannot be so big that it interferes with access to a neighbouring slot within the housing.

It is therefore an object of the present invention to provide a modular data acquisition system that ameliorates at least some of the aforementioned problems.

### DISCLOSURE OF THE INVENTION

Accordingly, the present invention is a mobile modular data acquisition system including at least one module, and interconnect means, that are adapted to connect a pair of adjacent modules, in the data acquisition system together. Each module in the data acquisition system includes a first face, and a second face, that is located opposite to the first face, and when two modules are placed side by side and connected together, the first face of the first module is in physical contact with the second face of the second module.

Preferably, when two modules are connected together, there is an electrical connection path between the modules.

Preferably, as additional modules are added to the data acquisition system, the electrical connection path is automatically extended to include the additional modules.

Preferably, the physical contact between adjacent modules in the data acquisition system is adapted to enable acoustic waves to transmit therethrough, with minimal loss of fidelity and minimal attenuation to the acoustic waves.

Preferably, each module includes at least one extension member that extends outwardly from the first face, and the second face includes a complimentary void, so that when at least a pair of modules are incorporated into the data acquisition system, the at least one extension member from the first face of one module is adapted to be inserted into the complimentary void in the second face of the adjacent module.

Preferably, the at least one extension member is a pin that projects orthogonally outward from the first face, and the complimentary void on the second face is a socket.

Preferably, the shape of the first side wall, and the shape of the second side wall, in each module, is uniform, in both size and shape, and includes additional projections, either upon each respective face, or around the periphery of the respective side walls, that are complimentary, and help to ensure the proper orientation of each adjacent pair of modules, and help to guide the at least one extension member into its corresponding void.

Preferably, the power supply includes a power plug, and a complimentary power socket, so that when two adjacent modules are interconnected, the power plug of the first module is automatically aligned with, and inserted into, the power socket of the second module.

Alternatively, emerging forms of wireless power supply means are used to power individual modules, thereby eliminating the need for a dedicated physical electrical bus and electrical inter-connector.

Optionally, the power plug is incorporated into the at least one extension member, and the power socket is incorporated into the complimentary void.

Optionally, the interconnection of a pair of modules, within the modular data acquisition system, also simultaneously interconnects data communication means between that pair of modules.

Preferably, the data communication means includes a data plug, and a complimentary data socket, so that when two adjacent modules are interconnected, the data plug of the first module is automatically aligned with, and inserted into, the power socket of the second module.

Optionally, the data plug is incorporated into the at least one extension member, and the data socket is incorporated into the complimentary void.

Optionally, magnetic means are adapted to hold the first face of one module in physical contact with the second face of an adjacent module.

Preferably, when two modules are interconnected, releasable locking means are incorporated so that the first face of the first module, and the second face of the second module can be releasably locked together.

Preferably, the releasable locking means includes an actuator, and the actuator is located upon the body of each respective module and is accessible to a user of the data acquisition system.

Preferably, the interconnection means, when locked by the releasable locking means, is vibration resistant, and meets, or exceeds, the minimum military standards for both ground and aerospace vehicles.

Preferably, the electrical connection between the modules in the data acquisition system is adapted to electrically ground each module and thereby ensure that the entire data acquisition system, regardless of the number of modules it may contain at any one time, has the same a constant found potential to any system the data acquisition apparatus may be incorporated into.

### BRIEF DESCRIPTION OF THE PREFERRED EMBODIMENTS

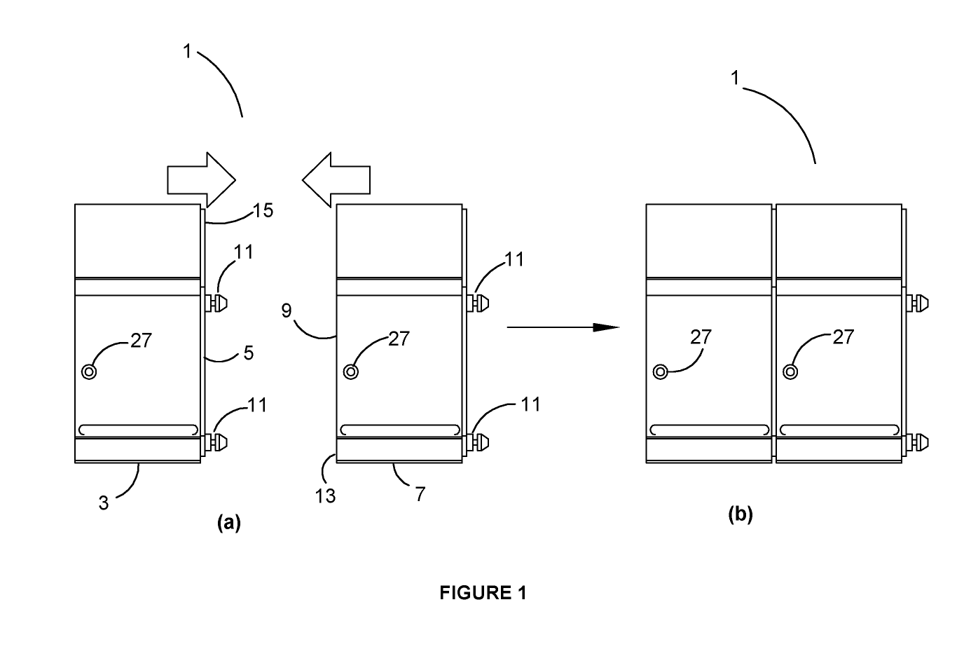

FIGS. 1 (a) and (b) show two modules ready to be interconnected in one form of the present invention.

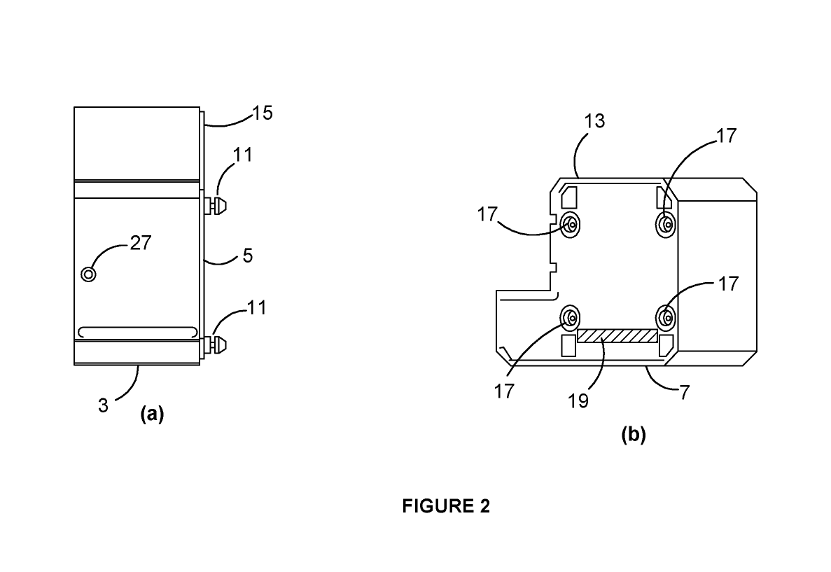

FIGS. 2 (a) and (b) show side views of a module used in accordance with one form of the present invention.

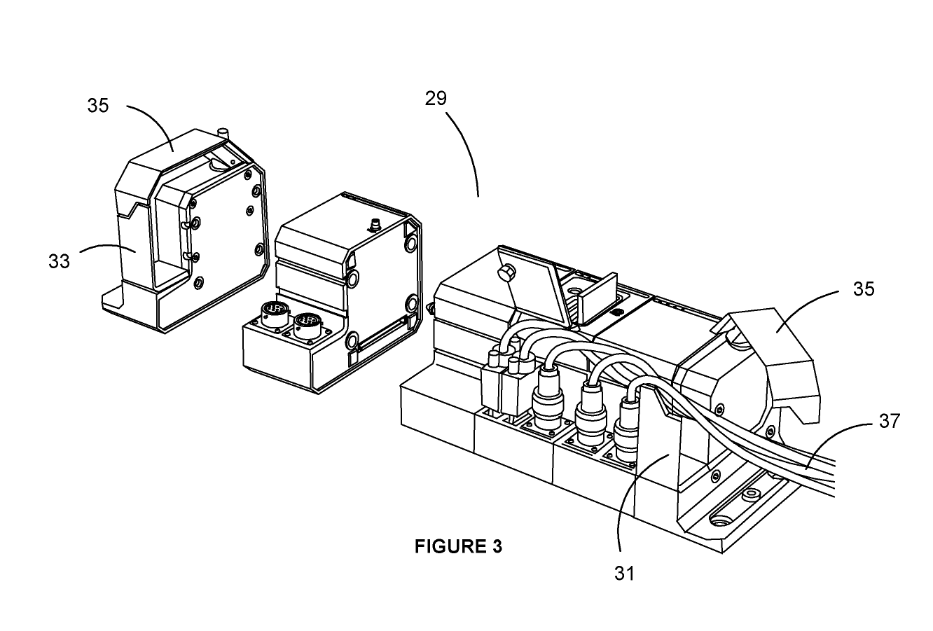

FIG. 3 shows an isometric view of a typical data acquisition system in accordance with he present invention, partially assembled.

### DETAILED DESCRIPTION OF PREFERRED EMBODIMENTS OF THE PRESENT INVENTION

Turning firstly to FIG. 1, we are shown an embodiment of the present invention where the data acquisition system 1 as illustrated, includes first module 3 having a first side face 5 and a second module 7 having a second side face 9. In this embodiment, the first face 5 includes a plurality of pins 11. The arrows indicate that the adjacent modules are moved into physical contact with one another so that the first face 5 is physically in contact with the second face 9. In this embodiment, the second face includes a skirt 13 that is arranged around the periphery of the second side face 9. The first side face 5 includes a complimentary projection 15, that also is located about the periphery of the first side face 5. The skirt 13 is adapted to accommodate the projection 15, and thereby ensure that the first and second side faces are in proper alignment with respect to one another. This also assists in guiding each pin 11 into its respective void.

One optional way that adjacent modules may be held together, is via magnetic means. Releasable fastening means may also be included. These are connected to an external actuator 27, and the actuator may include a key lock, or requires a special tool to operate the releasable locking means. Once the actuator 27 is actuated, the adjacent modules 3 and 7 are locked together.

Irrespective of whatever locking mechanism is used, the locking means between adjacent modules are vibration resistant, and meets, or exceeds, the minimum military standards for both ground and aerospace vehicles.

It should be noted that the data acquisition system depicted in these figures is illustrative only. There is no restriction on the number of modules that may be linked together to form the data acquisition system.

It should also be noted that no frame or other structure is required to house the modules. Each module is adapted to be interconnectable to an adjacent module. The data acquisition system is capable of being assembled from any number of modules so that the system can be constructed to best suit the data logging task at hand.

When two modules are connected together, the interface between the pair is adapted to permit the transmission of acoustic waves across the interface with minimal loss of fidelity and minimal attenuation.

Also, the interface between adjacent modules interconnected within the system may also be adapted to enable a physical data and/or power connection between the modules. Further, the interconnection between adjacent modules is adapted so that each module is electrically grounded, so that the data acquisition system has the same ground potential across the entire data acquisition interface, regardless of the number of modules contained within that system at any particular time, irrespective of the number or type of modules used within the system.

Turning to FIG. 2, we can see more detail of the second side face 9 on the second module 7. There is a total of four pins 11 in this example, on the first side face 5 of the first module 3. Each of these pins 11 have a corresponding socket 17. In this embodiment, data communication is established via the single data communication connector 19. This is optional. Similar means may be used to interconnect power between adjacent modules. Other means of inter-module communication of data also fall within the scope of this invention, including all forms of wireless and non-direct data transmission. A similar arrangement may be used to connect power between adjacent modules. In other embodiments, either the data communication inter-connection means, or the power inter-connection means, or both, are adapted to be integrated into at least one of the pins 11 and its corresponding socket 17. In this example, the actuator 27 is a screw type lock that is manually operated by a user using a suitable Allen type hex wrench, also commonly known as an Allen key.

Now turning to FIG. 3, where it can be seen that the data acquisition logger 29 is assembled by selecting the modules required to perform the data logging task on-hand by simply placing the required modules side by side and interconnecting them. Optionally a pair of end modules 31 and 33 respectively, may be used for the purpose of protecting the delicate power, and/or data interconnects present of the side faces of each module. Once the required type and number of modules are assembled. The end modules 31 and 33 are attached. These end modules may include cable retention means 35 that are adapted to retain any external cabling 37.

While the above description includes some embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge.

1. A mobile modular data acquisition system including at least one module, and interconnect means, that are adapted to connect a pair of adjacent modules, in the data acquisition system together, and wherein each module in the data acquisition system includes a first face, and a second face, that is located opposite to the first face, and when two modules are placed side by side and connected together, the first face of the first module is in physical contact with the second face of the second module.

2. The modular data acquisition system as defined in claim 1 wherein when two modules are connected together, there is an electrical connection path between the modules.

3. The modular data acquisition system as defined in claim 2 wherein as additional modules are added to the data acquisition system, the electrical connection path is automatically extended to include the additional modules.

4. The modular data acquisition system as defined in claim 1 wherein the physical contact between adjacent modules in the data acquisition system is adapted to enable acoustic waves to transmit therethrough, with minimal loss of fidelity and minimal attenuation to the acoustic waves.

5. The modular data acquisition system as defined in claim 1 wherein each module includes at least one extension member that extends outwardly from the first face, and the second face includes a complimentary void, so that when at least a pair of modules are incorporated into the data acquisition system, the at least one extension member from the first face of one module is adapted to be inserted into the complimentary void in the second face of the adjacent module.

6. The modular data acquisition system as defined in claim 5 wherein the at least one extension member is a pin that projects orthogonally outward from the first face, and the complimentary void on the second face is a socket.

7. The modular data acquisition system as defined in claim 5 wherein the shape of the first side wall, and the shape of the second side wall, in each module, is uniform, in both size and shape, and includes additional projections, either upon each respective face, or around the periphery of the respective side walls, that are complimentary, and ensure the proper orientation of each adjacent pair of modules, and help to guide the at least one extension member into its corresponding void.

8. The modular data acquisition system as defined in claim 7 wherein the power supply includes a power plug, and a complimentary power socket, so that when two adjacent modules are interconnected, the power plug of the first module is automatically aligned with, and inserted into, the power socket of the second module.

9. The modular data acquisition system as defined in claim 1 wherein wireless power supply means are used to power individual modules.

10. The modular data acquisition system as defined in claim 8 wherein the power plug is incorporated into the at least one extension member, and the power socket is incorporated into the complimentary void.

11. The modular data acquisition system as defined in claim 5 wherein the interconnection of a pair of modules, within the modular data acquisition system, also simultaneously interconnects data communication means between that pair of modules.

12. The modular data acquisition system as defined in claim 11 wherein the data communication means includes a data plug, and a complimentary data socket, so that when two adjacent modules are interconnected, the data plug of the first module is automatically aligned with, and inserted into, the power socket of the second module.

13. The modular data acquisition system as defined in claim 12 wherein the data plug is incorporated into the at least one extension member, and the data socket is incorporated into the complimentary void.

14. The modular data acquisition system as defined in claim 5 wherein magnetic means are adapted to hold the first face of one module in physical contact with the second face of an adjacent module.

15. The modular data acquisition system as defined in claim 5 wherein when two modules are interconnected, releasable locking means are incorporated so that the first face of the first module, and the second face of the second module can be releasably locked together.

16. The modular data acquisition system as defined in claim 15 wherein the releasable locking means includes an actuator, and the actuator is located upon the body of each respective module and is accessible to a user of the data acquisition system.

17. The modular data acquisition system as defined in claim 16 wherein the interconnection means, when locked by the releasable locking means, is vibration resistant, and meets, or exceeds, the minimum military standards for both ground and aerospace vehicles.

18. The modular data acquisition system as defined in claim 2 wherein the electrical connection between the modules in the data acquisition system is adapted to electrically ground each module and thereby ensure that the entire data acquisition system, regardless of the number of modules it may contain at any one time, has the same a constant found potential to any apparatus the data acquisition system may be incorporated into.
